(19) United States
(12) Patent Application Publication
(10) Pub. No.: US 2007/0084848 A1
(43) Pub. Date: Apr. 19, 2007

(54) HEAT TREATING APPARATUS AND METHOD

(75) Inventor: Tatsufumi KUSUDA, Kyoto (JP)

Correspondence Address: OSTROLENK FABER GERB & SOFFEN, 1180 AVENUE OF THE AMERICAS, NEW YORK, NY, 100368403, US

(73) Assignee: Dainippon Screen Mfg. Co., Ltd.

(21) Appl. No.: 11/560,635

(22) Filed: Nov. 16, 2006

Related U.S. Application Data
(62) Division of application No. 10/175,667, filed on Jun. 19, 2002.

(30) Foreign Application Priority Data
Jun. 20, 2001 (JP) 2001-185758
Sep. 26, 2001 (JP) 2001-337189
Mar. 20, 2002 (JP) 2002-078602

(51) Int. Cl. F27B 5/14; F27D 11/00

(52) U.S. Cl. 219/390

(57) ABSTRACT

A heat treating apparatus includes halogen lamps for preheating a semiconductor wafer to 400 to 600 degC., and xenon flash lamps for heating the substrate preheated by the halogen lamps, to 1,000 to 1,100 degC. in about 0.1 to 10 milliseconds by irradiating the wafer with flashes of light.

### BACKGROUND OF THE INVENTION

1. Field of the Invention

The present invention relates to a heat treating apparatus and method for heat treating substrates such as semiconductor wafers by irradiating the substrates with light.

2. Description of the Related Art

A heat treating apparatus such as a lamp annealing apparatus with halogen lamps is used to execute an ion activating step for a semiconductor wafer implanted with ions. Such a heat treating apparatus carries out an ion activation of the semiconductor wafer by heating the wafer to a temperature of 1,000 to 1,100 degC., for example. In this heat treating apparatus, the wafer is heated at a rate of about several hundred degrees per second by using the energy of light emitted from the halogen lamps.

However, it has been found that, even when the semiconductor wafer is ion-activated by the apparatus for heating the substrate at the rate of about several hundred degrees per second, the ions implanted in the semiconductor wafer present a blunt profile, i.e. the ions become dispersed. When such a phenomenon occurs, the ions implanted, even in high concentration, in the surface of the semiconductor wafer will become dispersed. Thus, the ions have to be implanted in a larger amount than is necessary.

To solve the above problem, it is conceivable to heat, in an extremely short time, only the surface of the semiconductor wafer implanted with ions, by using xenon flash lamps or the like to irradiate the surface of the wafer with flashes of light.

However, while a construction using xenon flash lamps can heat the surface of the semiconductor wafer in a very short time, the surface is heated only to about 500 degC. It is impossible to heat the semiconductor wafer to a temperature of about 1,000 to 1,100 degC. necessary for activating the ions in the wafer.

### SUMMARY OF THE INVENTION

The object of the present invention, therefore, is to provide a heat treating apparatus and method for preventing a dispersal of ions by heating a substrate to a treating temperature in a short time.

The above object is fulfilled, according to the present invention, by a heat treating apparatus for heat treating a substrate by irradiating the substrate with light, comprising an assist heating device for preheating the substrate to 400 to 600 degrees centigrade, and a flash heating device for heating the substrate preheated by the assist heating device, to 1,000 to 1,100 degrees centigrade by irradiating the substrate with flashes of light.

With this heat treating apparatus, the substrate is heated to a treating temperature in a short time, thereby preventing an ion dispersion occurring after the heat treatment.

In a preferred embodiment, the flash heating device is arranged to heat the substrate to 1,000 to 1,100 degrees centigrade in 0.1 to 10 milliseconds.

Preferably, the flash heating device comprises a plurality of xenon flash lamps.

The assist heating device may comprise a plurality of halogen lamps.

In another preferred embodiment, the assist heating device comprises a heating plate.

In another aspect of the invention, a heat treating apparatus for heat treating a substrate by irradiating the substrate with light, comprises an assist heating device for preheating the substrate to 400 to 600 degrees centigrade, and xenon flash lamps for heating the substrate preheated by the assist heating device, to a treating temperature by irradiating the substrate with flashes of light.

In a further aspect of the invention, there is provided a heat treating method for heat treating a substrate by irradiating the substrate with light, comprising an assist heating step for preheating the substrate to 400 to 600 degrees centigrade, and a flash heating step for heating the substrate preheated in the assist heating step, to 1,000 to 1,100 degrees centigrade by irradiating the substrate with flashes of light.

Other features and advantages of the present invention will be apparent from the following detailed description of the embodiments of the invention.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a sectional side view of a heat treating apparatus according to the invention;

FIG. 2 is a plan view schematically showing a positional relationship between xenon flash lamps and halogen lamps;

FIG. 3 is a time chart showing surface temperatures of a semiconductor wafer during a heat treating operation;

FIG. 4 is a plan view schematically showing a positional relationship between xenon flash lamps and halogen lamps in a modified example;

FIG. 5 is a sectional side view of a heat treating apparatus in a second embodiment of the invention;

FIG. 6 is another sectional side view of the heat treating apparatus in the second embodiment; and

FIG. 7 is a schematic plan view of the heat treating apparatus in the second embodiment.

### DESCRIPTION OF THE PREFERRED EMBODIMENTS

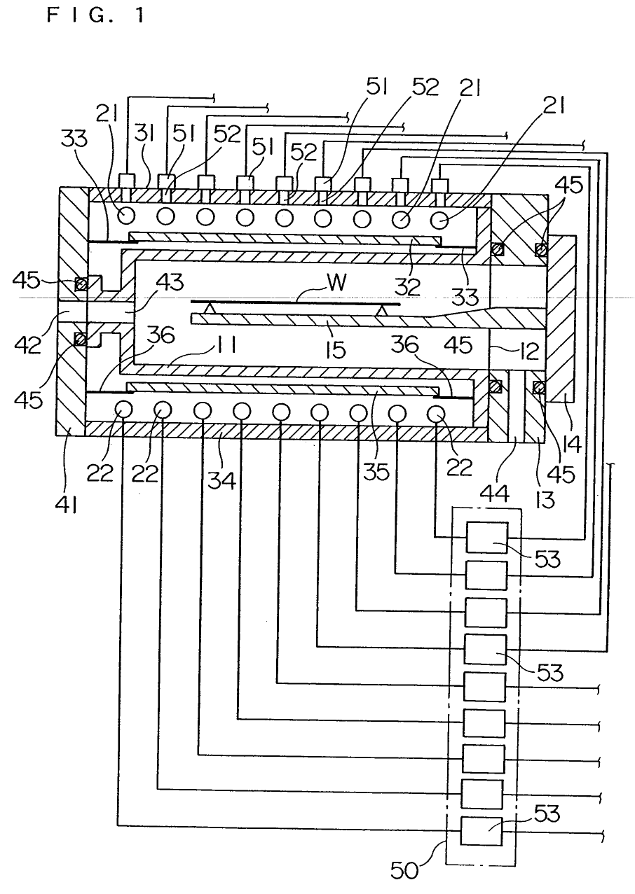

Embodiments of the present invention will be described hereinafter with reference to the drawings. FIG. 1 is a sectional side view of a heat treating apparatus in a first embodiment of the invention.

This heat treating apparatus includes a heat treating furnace 11 for receiving and heat treating a semiconductor wafer W therein. The heat treating furnace 11 is formed of an infrared ray transmitting material such as quartz. The heat treating furnace 11 has an opening 12 formed at one end thereof for loading and unloading the semiconductor wafer W into/out of the furnace 11.

A throat block 13 is disposed adjacent the opening 12 of heat treating furnace 11. The throat block 13 defines an opening closable by a gate valve 14. A susceptor 15 is secured to an inward side of the gate valve 14 for supporting the semiconductor wafer W in horizontal posture.

Thus, the gate valve 14 is horizontally reciprocable to move the semiconductor wafer W as supported by the susceptor 15 into and out of the heat treating furnace 11. With the gate valve 14 moving toward the heat treating furnace 11 into contact with the throat block 13, the opening formed in the throat block 13 is closed and the semiconductor wafer W supported by the susceptor 15 is set to a predetermined position inside the heat treating furnace 11.

A plurality of (nine in this embodiment) cylindrical xenon flash lamps 21 are arranged parallel to one another above the heat treating furnace 11.

Each xenon flash lamp 21 includes a glass tube filled with xenon gas, the glass tube having an anode and a cathode disposed at opposite ends and connected to a capacitor, and a trigger electrode wound around the glass tube. Since xenon gas is an electrical insulator, electricity does not flow through the glass tube in a normal state. However, when the insulation is broken by applying a high voltage to the trigger electrode, electricity stored in the capacitor flows through the glass tube. Joule heat thereby generated heats the xenon gas to emit light. The xenon flash lamps 21 are characterized by their capability of emitting extremely strong light compared with continuously lit light sources. This is achieved by prestored electrostatic energy being converted into an extremely short light pulse of 0.1 to 10 milliseconds.

On the other hand, a plurality of (nine in this embodiment) cylindrical halogen lamps 22 are arranged parallel to one another below the heat treating furnace 11. These halogen lamps 22 are tungsten halogen lamps, and have a function to heat the semiconductor wafer W at a rate of about several hundred degrees per second.

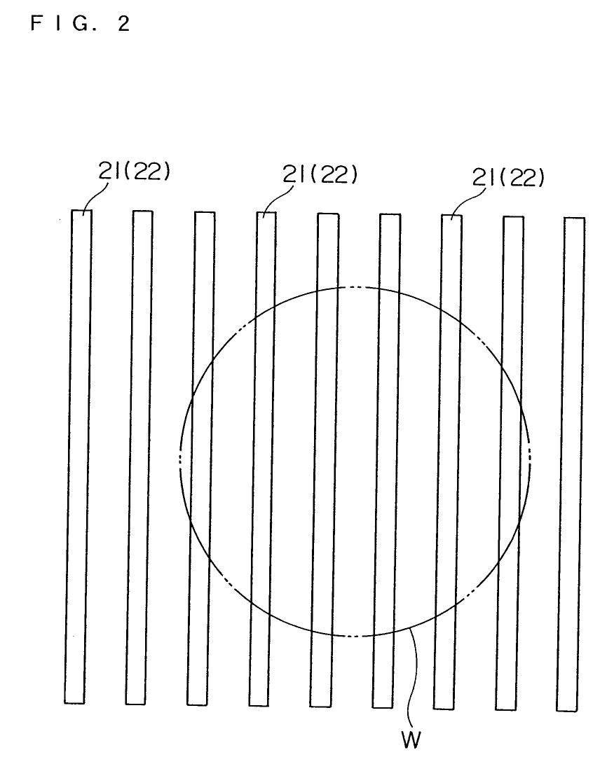

FIG. 2 is a plan view schematically showing a positional relationship between the xenon flash lamps 21 and halogen lamps 22.

As shown in FIGS. 1 and 2, the plurality of xenon flash lamps 21 and the plurality of halogen lamps 22 are arranged at the front surface side and the back surface side of semiconductor wafer W, respectively, and opposed to each other in a one-to-one relationship. That is, in plan view as shown in FIG. 2, the xenon flash lamps 21 and halogen lamps 22 are arranged to correspond to each other in position and in number.

In the embodiment shown in FIGS. 1 and 2, the xenon flash lamps 21 and halogen lamps 22 are arranged at equal intervals. However, adjacent the opening 12 or adjacent the opposite ends where temperature could drop easily, the xenon flash lamps 21 and halogen lamps 22 may be arranged at smaller intervals than in the middle region.

Referring again to FIG. 1, a reflector 31 is disposed above the xenon flash lamps 21. A reflector 34 is disposed below the halogen lamps 22. Further, a reflector 41 is disposed laterally of the xenon flash lamps 21 and halogen lamps 22.

Between the xenon flash lamps 21 and heat treating furnace 11 is a light diffuser plate 32 supported by a pair of support members 33. Between the halogen lamps 22 and heat treating furnace 11 is a light diffuser plate 35 supported by a pair of support member 36. These light diffuser plates 32 and 35 are formed of quartz glass which is an infrared ray transmitting material and whose surfaces have been given light diffusion treatment.

A gas inlet port 43 is formed laterally of the heat treating furnace 11. This gas inlet port 43 is connected to a source of a treating gas such as nitrogen gas through a gas introduction bore 42 formed in the reflector 41. The throat block 13 defines a gas exhaust port 44. This gas exhaust port 44 is connected to an exhaust gas disposal unit. To maintain a high degree of gastightness of the heat treating furnace 11, O-rings 45 are attached to the throat block 13 and reflector 41, respectively.

The reflector 31 has openings 52 formed in positions thereof opposed to the respective xenon flash lamps 21. Light quantity sensors 51 are arranged above the openings 52. The light quantity sensors 51 are provided for measuring quantities of light of the xenon flash lamps 21 through the openings 52.

The respective light quantity sensors 51 are connected to the halogen lamps 22 through a controller 50 including a plurality of control mechanisms 53. Based on measurements, provided by the light quantity sensors 51, of quantities of light of the flash emitted from the xenon flash lamps 21, the controller 50 controls outputs of the halogen lamps 22, i.e. a heating temperature by each halogen lamp 22.

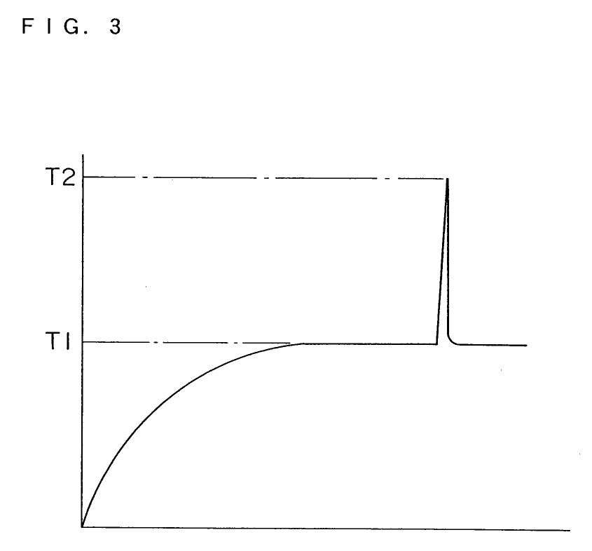

An operation of the above heat treating apparatus for heat treating the semiconductor wafer W will be described next. FIG. 3 is a time chart showing surface temperatures of semiconductor wafer W during the heat treating operation. In FIG. 3, the horizontal axis represents elapsed time, and the vertical axis the surface temperatures of semiconductor wafer W.

In this heat treating apparatus, the semiconductor wafer W as supported by the susceptor 15 is inserted into the heat treating furnace 11, and the opening in the throat block 13 is closed by the gate valve 14. Then the treating gas such as nitrogen gas is supplied into the heat treating furnace 11 through the gas inlet port 43, whereby the treating gas purges the heat treating furnace 11.

In this state, the halogen lamps 22 are lit. Then, the surface temperature of semiconductor wafer W is measured by a temperature sensor not shown. The halogen lamps 22 are used to preheat the semiconductor wafer W until the surface temperature of wafer W reaches temperature T1 shown in FIG. 3. This preheating temperature T1 is in a range of about 400 to 600 degC. Even if the semiconductor wafer W is heated to such preheating temperature T1, the ions implanted in the semiconductor wafer W remain unchanged, i.e. are never dispersed.

Once the surface temperature of semiconductor wafer W reaches the preheating temperature T1, the xenon flash lamps 21 are lit. The lighting time is about 0.1 to 10 milliseconds. In this way, the electrostatic energy prestored in the xenon flash lamps 21 is converted into such an extremely short light pulse. This results in very strong flashes being emitted.

In this state, the surface temperature of semiconductor wafer W reaches temperature T2 in FIG. 3. This temperature T2 is about 1,000 to 1,100 degC., i.e. a temperature necessary for treating the semiconductor wafer W. When the surface of semiconductor wafer W is heated to this treating temperature T2, the ions in the wafer W are activated.

As noted above, the surface of semiconductor wafer W is heated to the treating temperature T2 in the extremely short time of about 0.1 to 10 milliseconds. Consequently, the activation of the ions in the semiconductor wafer W is completed in a short time. This prevents the ions implanted in the semiconductor wafer W from becoming dispersed to present a blunt profile.

Further, as noted above, before lighting the xenon flash lamps 21 to heat the semiconductor wafer W, the halogen lamps 22 are used to raise the surface temperature of semiconductor wafer W to the preheating temperature T1 of about 400 to 600 degC. The semiconductor wafer W may therefore be heated by the xenon flash lamps 21 quickly to the treating temperature T2 of about 1,000 to 1,100 degC.

It is to be noted that the flashes emitted from the xenon flash lamps 21 used in the above heat treating apparatus undergo a remarkable time-dependent change in the quantity of light. That is, in flash lamps such as xenon flash lamps 21, the quantity of flashlight is variable with slight variations in electrical discharge time. The quantity of flashlight emitted from the flash lamps is variable also with variations in voltage and variations in electrostatic capacity of the capacitors.

In this heat treating apparatus, as noted hereinbefore, the plurality of xenon flash lamps 21 and the plurality of halogen lamps 22 are arranged at the front surface side and the back surface side of semiconductor wafer W, respectively, and opposed to each other in a one-to-one relationship. Based on the quantity of light of the flash emitted from each xenon flash lamp 21, the preheating temperature by the corresponding halogen lamp 22 is controlled, thereby coping with the time-dependent change in the quantity of light of the flash from the xenon flash lamp 21.

Specifically, in this heat treating apparatus, when the xenon flash lamps 21 are lit for ion-activating treatment of a first semiconductor wafer W, the light quantity sensors 51 measure the quantities of light of the flashes from the xenon flash lamps 21 through the openings 52 formed in the positions of the reflector 31 opposed to the respective xenon flash lamps 21. Each control mechanism 53 in the controller 50 adjusts the emission rate of the corresponding one of the halogen lamps 22 in accordance with the quantity of light of the flash from the opposite xenon flash lamp 21 measured by the associated light quantity sensor 51. In this way, the preheating temperature by each halogen lamp 22 is controlled.

Assume, for example, that the semiconductor wafer W should be heat treated at 1,000 degC., that the preheating temperature T1, shown in FIG. 3, by the halogen lamps 22 is set to 500 degC., and that the increase in the temperature of semiconductor wafer W by the action of the flashes from the xenon flash lamps 21 is set to 500 degC. In this case, the quantity of light of the flash from a certain one of the xenon flash lamps 21 measured by the associated light quantity sensor 51 may suggest a 485 degC. increase in the temperature of semiconductor wafer W by the action of the flash from this xenon flash lamp 21. Then, the preheating temperature by the halogen lamp 22 opposed to this xenon flash lamp 21 is set to 515 degC. As a result, the semiconductor wafer W may be heat treated at the temperature of 1,000 degC.

The above embodiment uses the xenon flash lamps 21 and halogen lamps 22 of cylindrical shape. However, the xenon flash lamps 21 and halogen lamps 22 used may have a different shape.

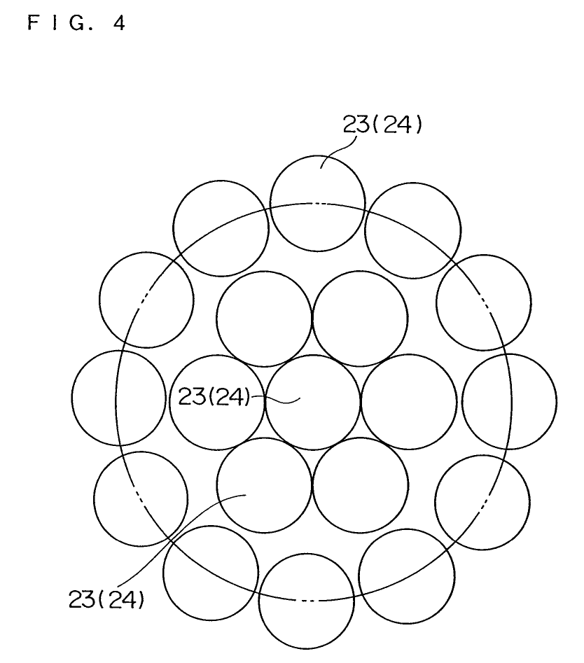

FIG. 4 is a plan view schematically showing a positional relationship between xenon flash lamps 23 and halogen lamps 24 in such a modified example.

In this example, the xenon flash lamps 23 and halogen lamps 24 used are circular in plan view. These lamps are arranged such that one xenon flash lamp 23 or halogen lamp 24 at the center is surrounded doubly by two groups of xenon flash lamps 23 or halogen lamps 24. In this example also, the plurality of xenon flash lamps 23 and the plurality of halogen lamps 24 are arranged at the front surface side and the back surface side of semiconductor wafer W, respectively, and opposed to each other in a one-to-one relationship. That is, in plan view as shown in FIG. 4, the xenon flash lamps 23 and halogen lamps 24 are arranged to correspond to each other in position and in number.

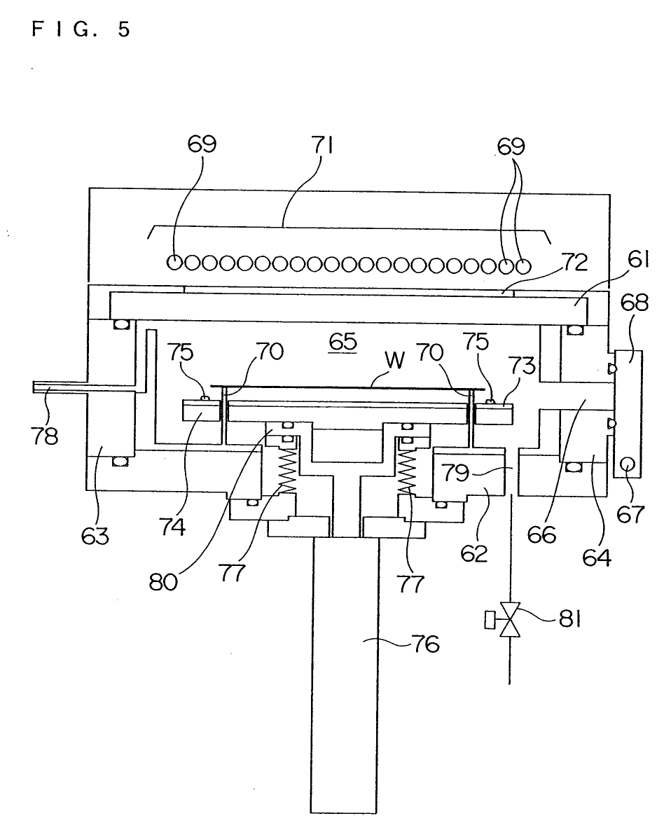

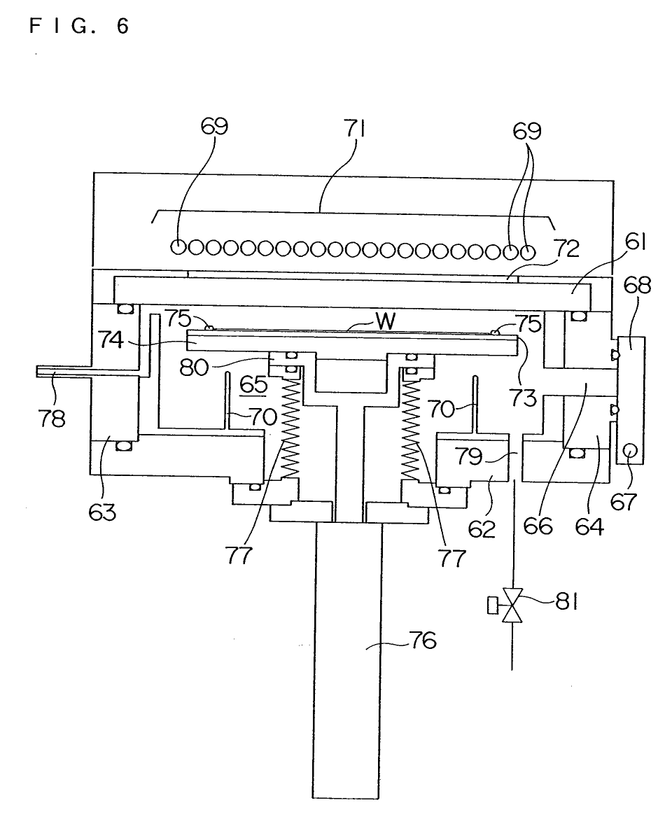

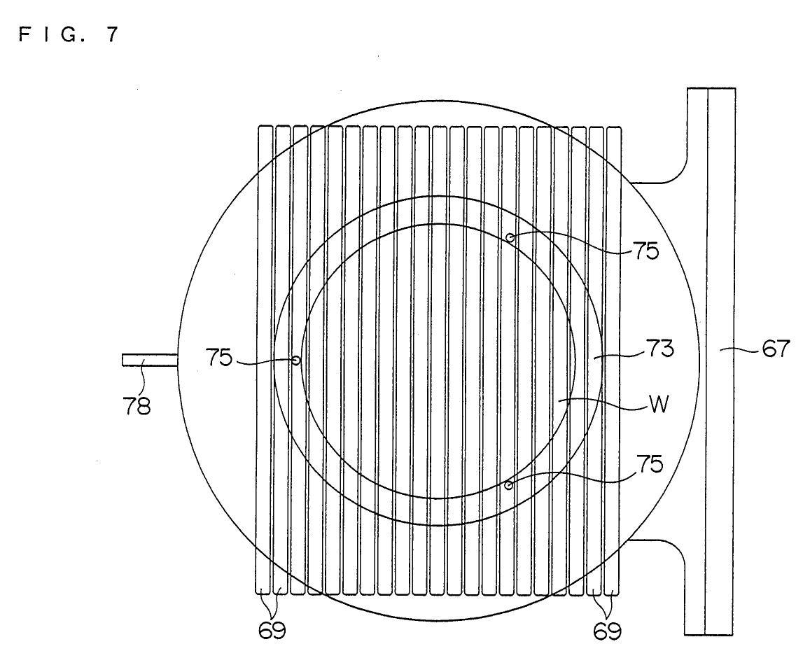

Another embodiment of the invention will be described next. FIGS. 5 and 6 are sectional side views of a heat treating apparatus in the second embodiment of the invention. FIG. 7 is schematic plan view thereof.

This heat treating apparatus includes a translucent plate 61, a bottom plate 62 and a pair of side plates 63 and 64 defining a heat treating chamber 65 for receiving and heat treating a semiconductor wafer W. The translucent plate 61 forming part of the heat treating chamber 65 is formed of an infrared ray transmitting material such as quartz. The bottom plate 62 forming part of the heat treating chamber 65 has support pins 70 erected thereon and extending through a thermal diffuser plate 73 and a heating plate 74 described hereinafter for supporting the semiconductor wafer W at the lower surface thereof.

The side plate 64 forming part of the heat treating chamber 65 defines an opening 66 for loading and unloading the semiconductor wafer W into/out of the heat treating chamber 65. The opening 66 is closable by a gate valve 68 pivoting about an axis 67. With the opening 66 opened, the semiconductor wafer W is loaded into the heat treating chamber 65 by a transport robot not shown.

A plurality of (21 in this embodiment) cylindrical xenon flash lamps 69 are arranged parallel to one another above the heat treating chamber 65. A reflector 71 is disposed above the xenon flash lamps 69.

As does each xenon flash lamp 21 in the first embodiment, each xenon flash lamp 69 includes a glass tube filled with xenon gas, the glass tube having an anode and a cathode disposed at opposite ends and connected to a capacitor, and a trigger electrode wound around the glass tube.

A light diffuser plate 72 is disposed between the xenon flash lamps 69 and translucent plate 61. The light diffuser plate 72 is formed of quartz glass which is an infrared ray transmitting material and whose surfaces have been given light diffusion treatment.

The heat treating chamber 65 has the thermal diffuser plate 73 and heating plate 74 arranged in the stated order therein. The thermal diffuser plate 73 has pins provided on the upper surface thereof for holding the semiconductor wafer W against displacement.

As are the halogen lamps 22 in the first embodiment, the heating plate 74 is provided for preheating the semiconductor wafer W. This heating plate 74 is formed of aluminum nitride, and contains a heater and a sensor for controlling the heater. The thermal diffuser plate 73 is provided for diffusing thermal energy from the heating plate 74 to heat the semiconductor wafer W uniformly. The thermal diffuser plate 73 is formed of a material having a relatively small coefficient of thermal conductivity such as sapphire (aluminum oxide) or quartz.

The thermal diffuser plate 73 and heating plate 74 are driven by an air cylinder 76 to move vertically between a position shown in FIG. 5 for loading and unloading the semiconductor wafer W, and a position shown in FIG. 6 for heat treating the wafer W.

The thermal diffuser plate 73 and heating plate 74 are lowered to the position shown in FIG. 5 for loading and unloading the semiconductor wafer W. In this position, the transport robot not shown is used to carry the semiconductor wafer W in through the opening 66 and place the wafer W on the support pins 70, or to remove the wafer W from the support pins 70 and carry the wafer W out through the opening 66. In this state, upper ends of the support pins 70 extend through bores formed in the thermal diffuser plate 73 and heating plate 74, and project upward from the surface of thermal diffuser plate 73. For expediency of description, FIG. 5 shows the bores in the thermal diffuser plate 73 and heating plate 74 which actually are invisible in side view.

The thermal diffuser plate 73 and heating plate 74 are raised to the position shown in FIG. 6, in which the two plates 73 and 74 are above the upper ends of support pins 70, for heat treating the semiconductor wafer W. In this state, the semiconductor wafer W is raised, with the lower surface thereof supported by the upper surface of thermal diffuser plate 73, to the position close to the translucent plate 61.

Particles may be generated when the thermal diffuser plate 73 and heating plate 74 are moved up and down between the loading and unloading position and the heat treating position. In order to prevent such particles from adhering to the semiconductor wafer W, a bellows 77 is disposed to extend between a support member 80 supporting the heating plate 74 and the bottom plate 62 of heat treating chamber 65.

A gas inlet 78 is formed in the side wall 63 remote from the opening 66 of the heat treating chamber 65. This gas inlet 78 is connected to a source of a treating gas such as nitrogen gas. The bottom plate 62 of heat treating chamber 65 defines a gas exhaust port 79. This gas exhaust port 79 is connected to an exhaust gas disposal unit through a switch valve 81.

An operation of the heat treating apparatus for heat treating the semiconductor wafer W in the second embodiment will be described next.

In this heat treating apparatus, with the thermal diffuser plate 73 and heating plate 74 lowered to the position shown in FIG. 5 for loading and unloading the semiconductor wafer W, the transport robot not shown carries the semiconductor wafer W in through the opening 66 and places the wafer W on the support pins 70. Upon completion of the wafer loading operation, the opening 66 is closed by the gate valve 68. At this time, the thermal diffuser plate 73 and heating plate 74 are heated by the heater mounted in the heating plate 74.

Subsequently, the thermal diffuser plate 73 and heating plate 74 are raised by the air cylinder 76 to the position shown in FIG. 6 for heat treating the semiconductor wafer W. Then the treating gas such as nitrogen gas is supplied into the heat treating chamber 65 through the gas inlet 78, whereby the treating gas purges the heat treating chamber 65.

In this state, the semiconductor wafer W is heated through contact with the hot thermal diffuser plate 73. The surface temperature of semiconductor wafer W is measured by a temperature sensor not shown. The semiconductor wafer W is preheated through the thermal diffuser plate 73 until the surface temperature of wafer W reaches temperature T1 in FIG. 3. This preheating temperature T1 is in a range of about 400 to 600 degC. Even if the semiconductor wafer W is heated to such preheating temperature T1, the ions implanted in the semiconductor wafer W remain unchanged, i.e. are never dispersed.

Once the surface temperature of semiconductor wafer W reaches the preheating temperature T1, the xenon flash lamps 69 are lit. The lighting time is about 0.1 to 10 milliseconds. In this way, the electrostatic energy prestored in the xenon flash lamps 69 is converted into such an extremely short light pulse. This results in very strong flashes being emitted.

In this state, the surface temperature of semiconductor wafer W reaches temperature T2 in FIG. 3. This temperature T2 is about 1,000 to 1,100 degC., i.e. a temperature necessary for treating the semiconductor wafer W. When the surface of semiconductor wafer W is heated to this treating temperature T2, the ions in the wafer W are activated.

As in the first embodiment, the surface of semiconductor wafer W is heated to the treating temperature T2 in the extremely short time of about 0.1 to 10 milliseconds. Consequently, the activation of the ions in the semiconductor wafer W is completed in a short time. This prevents the ions implanted in the semiconductor wafer W from becoming dispersed to present a blunt profile.

As noted above, before lighting the xenon flash lamps 69 to heat the semiconductor wafer W, the heating plate 74 is used to raise the surface temperature of semiconductor wafer W to the preheating temperature T1 of about 400 to 600 degC. The semiconductor wafer W may therefore be heated by the xenon flash lamps 21 quickly to the treating temperature T2 of about 1,000 to 1,100 degC.

Further, since the thermal diffuser plate 73 is disposed between the semiconductor wafer W and heating plate 74, the entire surface of semiconductor wafer W may be heated uniformly by using the heating plate 74 having a heater mounted therein.

The present invention may be embodied in other specific forms without departing from the spirit or essential attributes thereof and, accordingly, reference should be made to the appended claims, rather than to the foregoing specification, as indicating the scope of the invention.

This application claims priority benefit under 35 U.S.C. Section 119 of Japanese Patent Applications No. 2001-185758 filed in the Japanese Patent Office on Jun. 20, 2001, No. 2001-337189 filed in the Japanese Patent Office on Sep. 26, 2001 and No. 2002-078602 filed in the Japanese Patent Office on Mar. 20, 2002, the entire disclosure of which is incorporated herein by reference.

1-12. (canceled)

13. A heat treating method for heat treating an ion-implanted semiconductor wafer by irradiating the wafer with light, comprising:
an assist heating step for preheating the wafer to 400 to 600 degrees centigrade; and
a flash heating step for heating the substrate preheated in said assist heating step, to 1,000 to 1,100 degrees centigrade by irradiating the substrate with flashes of light so as to ion-activate said wafer.

14. A heat treating method as defined in claim 13, wherein said flash heating step is executed to heat the wafer to 1,000 to 1,100 degrees centigrade in 0.1 to 10 milliseconds.

15. A heat treating method as defined in claim 14, wherein said flash heating step is executed to heat the wafer to 1,000 to 1,100 degrees centigrade by using a plurality of xenon flash lamps.

16. A heat treating method as defined in claim 15, wherein said assist heating step is executed to preheat the wafer to 400 to 600 degrees centigrade by using a plurality of halogen lamps.

17. A heat treating method as defined in claim 15, wherein said assist heating step is executed to preheat the wafer to 400 to 600 degrees centigrade by using a heating plate.

18. A heat treating method as defined in claim 15, further comprising the step of arranging said plurality of xenon flash lamps to oppose an entire top surface of the wafer.

19. A heat treating method as defined in claim 14, comprising the step of heating only a top surface of the preheated wafer to 1,000 to 1,100 degrees in said flash heating step.

20. A heat treating method as defined in claim 19, comprising the step of ion-activating only said heated top surface of said wafer in said flash-heating step.

21. A heat treating method as defined in claim 17, further comprising the step of supporting a lower surface of the wafer on a surface of said heating plate.

22. A heat treating method as defined in claim 21, further comprising the step of placing a thermal diffuser between the wafer and the heating plate.

23. A heat treating method as defined in claim 13, wherein a lower surface of the wafer is supported by an assist heating device in said assist heating step.

24. A heat treating method as defined in claim 23, comprising the step of supporting the lower surface of the wafer on a heating plate.

25. A heat treating method as defined in claim 24, further comprising the step of placing a thermal diffuser between the wafer and the heating plate.
